(19) United States
(12) Patent Application Publication
(10) Pub. No.: US 2009/0271805 A1
(43) Pub. Date: Oct. 29, 2009

(54) METHOD AND SYSTEM FOR INTEGRATING AT LEAST ONE MULTIMEDIA DEVICES WITH AN ELECTRONIC DEVICE

(75) Inventor: CHUNG-CHIN CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/255,654

(22) Filed: Oct. 21, 2008

(30) Foreign Application Priority Data
Apr. 24, 2008 (CN) 200810301296.5

(51) Int. Cl. G06F 9/54; G06F 13/00

(52) U.S. Cl. 719/322; 710/305

(57) ABSTRACT

A computer-implemented method and system for integrating at least one multimedia device with an electronic device is provided. The electronic device includes a memory module loaded with audio drivers, video drivers and control drivers. The method includes retrieving the at least one multimedia device connected thereto to identify audio data, video data and control channels between the electronic device and the at least one multimedia device, respectively operating with the audio and video drivers to conduct audio and video data transmission by the respective audio and video data channels, and operating with the control drivers to conduct control signals transmission by the control channels so that each of the electronic device and the at least one multimedia device are capable of controlling each other to display multimedia data stored on the electronic device or the at least one multimedia device.

### BACKGROUND

1. Field of the Invention

Embodiments of the present disclosure relate to multimedia integration, and more particularly to a method and a system for integrating at least one multimedia devices with an electronic device.

2. Description of Related Art

With an increased demand for multimedia, conventional multimedia devices, such as an MP3 player or a DVD recorder, having a single functionality no longer satisfy consumers' escalating demands for versatile and highly interactive functionality. As such, modern multimedia devices possessing characteristics of high integration and easy operation have been developed nowadays.

In addition, with the prevalence of portable electronic devices, users demand more than simply basic functions such as placing/answering phone calls and sending/receiving short messages, expecting the capability to deal with multimedia files. However, typical portable electronic devices are incapable of integrating the multimedia files stored on the multimedia devices, and vice versa.

Accordingly, a method and a system for integrating at least one multimedia device with an electronic device are called for in order to overcome the limitations described.

### SUMMARY

A computer-implemented method for integrating at least one multimedia device with an electronic device is provided. The electronic device includes a memory module loaded with audio drivers, video drivers and control drivers. The method includes retrieving the at least one multimedia device connected thereto to identify audio data, video data and control channels between the electronic device and the at least one multimedia device, respectively operating with the audio and video drivers to conduct audio and video data transmission by the respective audio and video data channels, and operating with the control drivers to conduct control signals transmission by the control channels so that each of the electronic device and the at least one multimedia device are capable of controlling each other to display multimedia data stored on the electronic device or the at least one multimedia device.

Other advantages and novel features of the present method and system for integrating at least one multimedia device with an electronic device will become more apparent from the following detailed description of certain inventive embodiments when taken in conjunction with the accompanying drawings.

### BRIEF DESCRIPTION OF THE DRAWINGS

FIG. 1 is a block diagram of an embodiment of a system for integrating at least one multimedia device with an electronic device; and

FIG. 2 is a flowchart of an embodiment of a method for integrating at least one multimedia device with an electronic device.

### DETAILED DESCRIPTION OF CERTAIN INVENTIVE EMBODIMENTS

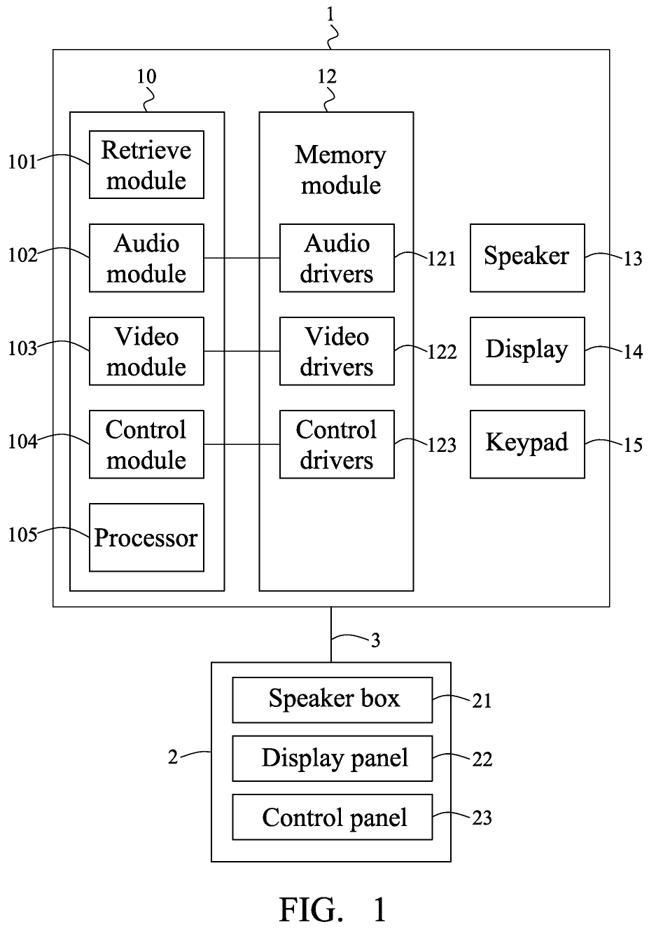

FIG. 1 is a block diagram of an embodiment of a system 10 for integrating at least one multimedia device 2 (hereinafter “the system 10”). In one embodiment, an electronic device 1, such as a mobile phone, connects to the at least one multimedia device 2 and includes the system 10 for integrating the at least one multimedia device 2. In other embodiments, portable and non-portable electronic devices other than the mobile phone shown here, such as notebook computers and personal digital assistants (PDAs), for example, may equally utilize the system 10, without departing from the spirit of the disclosure.

The electronic device 1 connects to the at least one multimedia device 2 by a local interface 30. The local interface 30 may be a standard Universal Serial Bus (USB) interface or a Bluetooth interface, but the disclosure is not limited thereto.

In one embodiment, the electronic device 1 also includes a memory module 12, a speaker 13, a display 14 and a keypad module 15 with a plurality of keys arranged thereon, in addition to other hardware and software components of the electronic device 1.

The memory module 12 is loaded with audio drivers 121, video drivers 122, and control drivers 123. The audio drivers 121 are for coordinating audio data transmitted by audio data channels between the electronic device 1 and the at least one multimedia device 2. The video drivers 122 are for coordinating video data transmitted by video data channels between the electronic device 1 and the at least one multimedia device 2. The control drivers 123 are for coordinating control signals transmitted by control channels between the electronic device 1 and the at least one multimedia device 2.

In one embodiment, the at least one multimedia device 2 includes a speaker box 21, a display panel 22 and a control panel 23. In one embodiment, the speaker box 21 includes a plurality of speakers for playing audio data. In alternative embodiments, the speaker box 21 is a speaker. The display panel 22 is for displaying video information. The control panel 23 includes a plurality of control keys for controlling operations of the at least one multimedia device 2, such as playing a multimedia file. In one embodiment, the control keys includes “play,” “pause,” “next file,” and “previous file,” but the disclosure is not limited thereto.

In one embodiment, the system 10 includes a retrieve module 101, an audio module 102, a video module 103, a control module 104, and a processor 105 for executing one or more operations between the above modules. All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

The retrieve module 101 is configured for retrieving the at least one multimedia device 2 connected to the electronic device 1 to identify the audio data channels, video data channels and the control channels connected thereto.

The audio module 102 is configured for cooperatively operating with the audio drivers 121 stored in the memory module 12 to conduct audio data transmission by the audio data channels between the electronic device 1 and the at least one multimedia device 2. Thus, the speaker 13 of the electronic device 1 is capable of displaying audio data stored in the at least one multimedia device 2, and the speaker box 21 of the at least one multimedia device 2 is capable of displaying audio data stored in the electronic device 1.

The video module 103 is configured for cooperatively operating with the video drivers 122 stored in the memory module 12 to conduct video data transmission by the video data channels between the electronic device 1 and the at least one multimedia device 2. Thus, the display 14 of the electronic device 1 is capable of displaying video data stored in the at least one multimedia device 2, and the display panel 22 of the at least one multimedia device 2 is capable of displaying video data stored in the electronic device 1.

The control module 104 is configured for cooperatively operating with the control drivers 123 stored in the memory module 12 to conduct control signals transmission by the control channel between the electronic device 1 and the at least one multimedia device 2.

In one embodiment, the control signals generated by the keys of the keypad module 15 are transmitted to the at least one multimedia device 2 for controlling operations of the at least one multimedia device 2. In other words, the keys of the keypad module 15 can be emulated as control keys of the control panel 23 of the at least one multimedia device 2. In alternative embodiments, a touch panel, instead of the keypad module 15, can be utilized by the electronic device 1 to generate the control signals for controlling operations of the at least one multimedia device 2.

Understandably, the control keys of the control panel 23 of the at least one multimedia device 2 can also be emulated as the keys of the keypad module 15. Thus, the control signals generated by the control keys of the control panel 23 are transmitted to the electronic device 1 for displaying the multimedia data stored on the electronic device 1. From the foregoing it will be seen that each of the electronic device 1 and the at least one multimedia device 2 are capable of controlling each other to display multimedia data stored on the electronic device 1 or the at least one multimedia device 2.

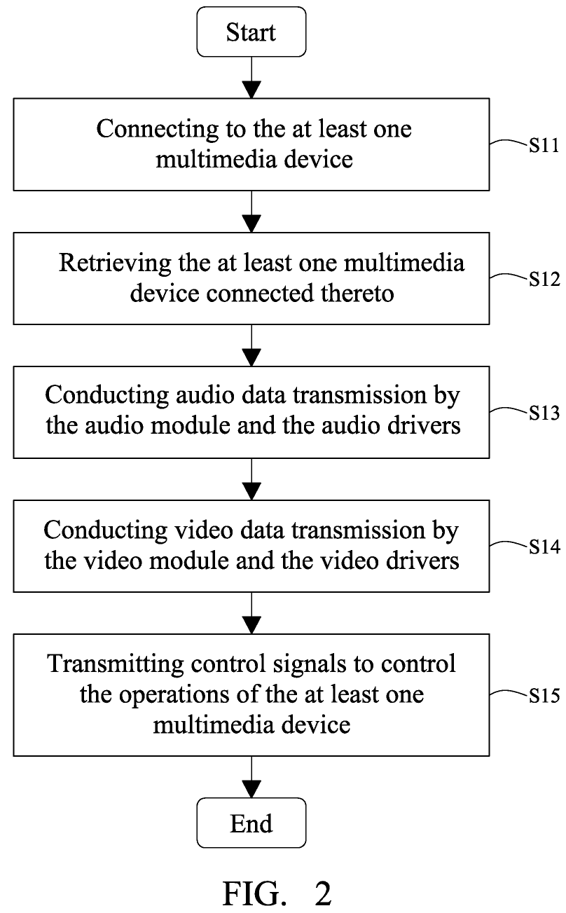

FIG. 2 is a flowchart of an embodiment of a method for integrating at least one multimedia device with an electronic device 1. The method of FIG. 2 may used for integrating multimedia data and multimedia functions of the electronic device 1 and the at least one multimedia device 2. Depending on the embodiment, additional blocks may be added or deleted and the blocks may be executed in order other than that described.

In block S11, the electronic device 1 connects to the at least one multimedia device 2 by a local interface 30. In block S12, the retrieve module 101 retrieves the at least one multimedia device 2 connected thereto to identify audio data channels, video data channels and the control data channels between the electronic device 1 and the at least one multimedia device 2.

In block S13, the audio module 102 cooperatively operates with the audio drivers 121 stored in the memory module 12 to conduct audio data transmission by the audio data channels between the electronic device 1 and the at least one multimedia device 2.

In block S14, the video module 103 cooperatively operates with the video drivers 122 stored in the memory module 12 to conduct video data transmission by the video data channels between the electronic device 1 and the at least one multimedia device 2.

In block S15, the control module 104 cooperatively operates with the control drivers 123 stored in the memory module 12 to conduct control signals transmission between the electronic device 1 and the at least one multimedia device 2.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A computing system for integrating at least one multimedia device with an electronic device comprising a memory module loaded with audio drivers, video drivers, and control drivers, the system comprising:
a retrieve module configured for retrieving the at least one multimedia device connected to the electronic device to identify audio data channels, video data channels and the control channels between the electronic device and the at least one multimedia device;
an audio module cooperatively operating with the audio drivers to conduct audio data transmission by the audio data channel between the electronic device and the at least one multimedia device;
a video module cooperatively operating with the video drivers to conduct video data transmission by the video data channel between the electronic device and the at least one multimedia device;
a control module cooperatively operating with the control drivers to conduct control signals transmission by the control channel so that each of the electronic device and the at least one multimedia device are capable of controlling each other to display multimedia data stored on the electronic device or the at least one multimedia device; and
a processor for executing the retrieve module, the audio module, the video module, and the control module.

2. The system as claimed in claim 1, wherein the electronic device connects to the at least one multimedia device by a local interface.

3. The system as claimed in claim 2, wherein the local interface is a standard Universal Serial Bus (USB) interface.

4. The system as claimed in claim 2, wherein the electronic device further comprises a keypad module with a plurality of keys arranged thereon for controlling operations of the multimedia device by sending the control signals via the control channels therebetween.

5. The system as claimed in claim 2, wherein the electronic device further comprises a speaker capable of displaying audio data stored in the at least one multimedia device.

6. The system as claimed in claim 2, wherein the electronic device further comprises a display capable of displaying video data stored in the at least one multimedia device.

7. The system as claimed in claim 2, wherein the at least one multimedia device further comprises a speaker box, a display panel and a control panel comprising a plurality of control keys for controlling operations of the at least one multimedia device.

8. The system as claimed in claim 7, wherein the speaker box of the at least one multimedia device is capable of displaying audio data stored in the electronic device.

9. The system as claimed in claim 8, wherein the display panel of the at least one multimedia device is capable of displaying video data stored in the electronic device.

10. A computer-implemented method for integrating at least one multimedia device with an electronic device comprising a memory module loaded with audio drivers, video drivers and control drivers, the method comprising:
a retrieve step for retrieving the at least one multimedia device connected to the electronic device to identify audio data channels, video data channels and the control channels between the electronic device and the at least one multimedia device;
an audio step for operating with the audio drivers to conduct audio data transmission by the audio data channels;
a video step for operating with the video drivers to conduct video data transmission by the video data channels; and
a control step for operating with the control drivers to conduct control signals transmission by the control channels so that each of the electronic device and the at least one multimedia device are capable of controlling each other to display multimedia data stored on the electronic device or the at least one multimedia device.

11. The method as claimed in claim 10, wherein the electronic device connects to the at least one multimedia device by a local interface.

12. The method as claimed in claim 11, wherein the local interface is a standard Universal Serial Bus (USB) interface.

13. The method as claimed in claim 11, wherein the control step further comprising:
generating control signals by a plurality of keys of the electronic device;
transmitting the control signals to the at least one multimedia device by the control channels therebetween.

14. The method as claimed in claim 11, wherein the control step further comprising:
displaying audio data stored in the at least one multimedia device by a speaker of the electronic device.

15. The method as claimed in claim 11, wherein the control step further comprising:
displaying video data stored in the at least one multimedia device by a display of the electronic device.

16. The method as claimed in claim 11, wherein the at least one multimedia device further comprises a speaker box, a display panel and a control panel comprising a plurality of control keys for controlling operations of the at least one multimedia device.

17. The method as claimed in claim 16, wherein the control step further comprising:
displaying audio data stored in the electronic device by the speaker box of the at least one multimedia device.

18. The method as claimed in claim 16, wherein the control step further comprising:
displaying video data stored in the electronic device by the display panel of the at least one multimedia device.
